(19) United States
(12) Patent Application Publication
(10) Pub. No.: US 2015/0194132 A1
(43) Pub. Date: Jul. 9, 2015

(54) Determining a Rotation of Media Displayed on a Display Device by a Wearable Computing Device

(71) Applicants: Harvey Ho, Mountain View, CA (US); Adrian Wong, Mountain View, CA (US)

(72) Inventors: Harvey Ho, Mountain View, CA (US); Adrian Wong, Mountain View, CA (US)

(73) Assignee: GOOGLE INC., Mountain View, CA (US)

(21) Appl. No.: 13/408,885

(22) Filed: Feb. 29, 2012

(51) Int. Cl. G09G 5/36; G02B 27/00; G02B 27/01

(52) U.S. Cl. CPC G09G 5/363; G02B 27/0172; G02B 27/0093; G09G 2340/0492; G02B 2027/0178

(57) ABSTRACT

The present disclosure describes example systems and methods for determining a rotation of a display orientation of media displayed on a display device by a wearable computing device. The systems and methods may be directed to identifying an orientation of a display device based on information corresponding to a field of view of a camera of the wearable computing device and identifying a reference orientation. The rotation of the display orientation of the media may be based on a comparison of the orientation of the display device with the reference orientation. The rotation may align an axis of the display orientation with an axis of the reference orientation.

### BACKGROUND

Many electronic devices have the ability to display media. The orientation of the media may match the orientation of the display screen. Some electronic devices have a display screen that is able to change the way an image is displayed on the display screen based on a physical orientation of the device. For example, a tablet computer may be display media in a portrait aspect ratio or a landscape aspect ratio. Other electronic devices may provide a user with an option to rotate media displayed on the display device by fixed amounts, such as increments of ninety-degrees.

### SUMMARY

In one example, a method is provided for rotating a display orientation of media displayed on a display device. The method may include receiving information corresponding to a field of view of a camera of a wearable computing device. The field of view of the camera may include a display device. The method may also include identifying an orientation of the display device based on the information corresponding to the field of view of the camera. The method may further include identifying a reference orientation that includes an orientation of the wearable computing device. The method may additionally include determining, by the wearable computing device, a rotation of a display orientation of media displayed on the display device. The rotation may be based on a comparison of the orientation of the display device with the reference orientation. The method may also include providing information indicative of the rotation of the display orientation to the display device.

In another example, non-transitory computer-readable memory having stored thereon instructions executable by a computing device to perform functions is provided. The functions may include receiving information corresponding to a field of view of a camera of a wearable computing device. The field of view of the camera may include a display device. The functions may also include identifying an orientation of the display device based on the information corresponding to the field of view of the camera. The functions may further include identifying a reference orientation that includes an orientation of the wearable computing device. The functions may additionally include determining, by the wearable computing device, a rotation of a display orientation of media displayed on the display device. The rotation may be based on a comparison of the orientation of the display device with the reference orientation. The functions may also include providing information indicative of the rotation of the display orientation to the display device.

In another example, a wearable computing device is provided. The wearable computing device may include a camera having a field of view and a processor. The processor may be configured to receive information corresponding to the field of view of the camera that includes a display device. The processor may also be configured to identify an orientation of the display device based on the information corresponding to the field of view of the camera. The processor may further be configured to identify a reference orientation that includes an orientation of the wearable computing device. The processor may additionally be configured to determine a rotation of a display orientation of media displayed on the display device. The rotation may be based on a comparison of the orientation of the display device with the reference orientation. The processor may also be configured to provide information indicative of the rotation to the display device.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1A illustrates an example system for receiving, transmitting, and displaying data.

FIG. 1B illustrates an alternate view of the system illustrated in FIG. 1A.

FIG. 2A illustrates another example system for receiving, transmitting, and displaying data.

FIG. 2B illustrates yet another example system for receiving, transmitting, and displaying data.

FIG. 3 illustrates a simplified block diagram of an example computer network infrastructure.

FIG. 4 illustrates a simplified block diagram depicting example components of an example computing system.

FIG. 5 is a block diagram of an example method for determining a rotation of a display orientation of media displayed on a display device in accordance with at least some embodiments described herein.

FIGS. 6A-6D illustrate examples of a wearable computing device identifying an orientation of a display device.

FIGS. 7A-7B illustrate examples of reference orientations based on an orientation of a head-mounted display of a wearable computing device.

FIGS. 8A-8B illustrate an example of a determination of a rotation of a display orientation based on a comparison of an orientation of a display device with a reference orientation.

FIGS. 9A-9C illustrate an example of a wearable computing device implementing a portion of the method 500 to rotate a display orientation of media displayed on a display device.

FIGS. 10A-10C illustrate another example of a wearable computing device implementing a portion of the method 500 to rotate a display orientation of media displayed on a display device.

FIGS. 11A-11B illustrate yet another example of a wearable computing device implementing a portion of the method 500 to adjust a display orientation of media displayed on a display device.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. Overview

Disclosed herein are example methods and systems for determining a rotation of a display orientation of media displayed on a display device by a wearable computing device. An example method may include receiving information corresponding to a field of view of a camera of a wearable computing device. The field of view of the camera may include a display device. The example method may also include the wearable computing device identifying an orientation of the display device based on the information corresponding to the field of view and identifying a reference orientation that includes an orientation of the wearable computing device. In some examples, the reference orientation may include an orientation of a head-mounted display of the wearable computing device.

The example method may further include determining, by the wearable computing device, a rotation of a display orientation of media displayed on the display device. The rotation may be based on a comparison of the orientation of the display device with the reference orientation. In one example, the rotation may align the display orientation with reference orientation such that an axis of the display orientation is parallel to an of the reference orientation. The method may also include providing information indicative of the rotation to the display device.

2. Example System and Device Architecture

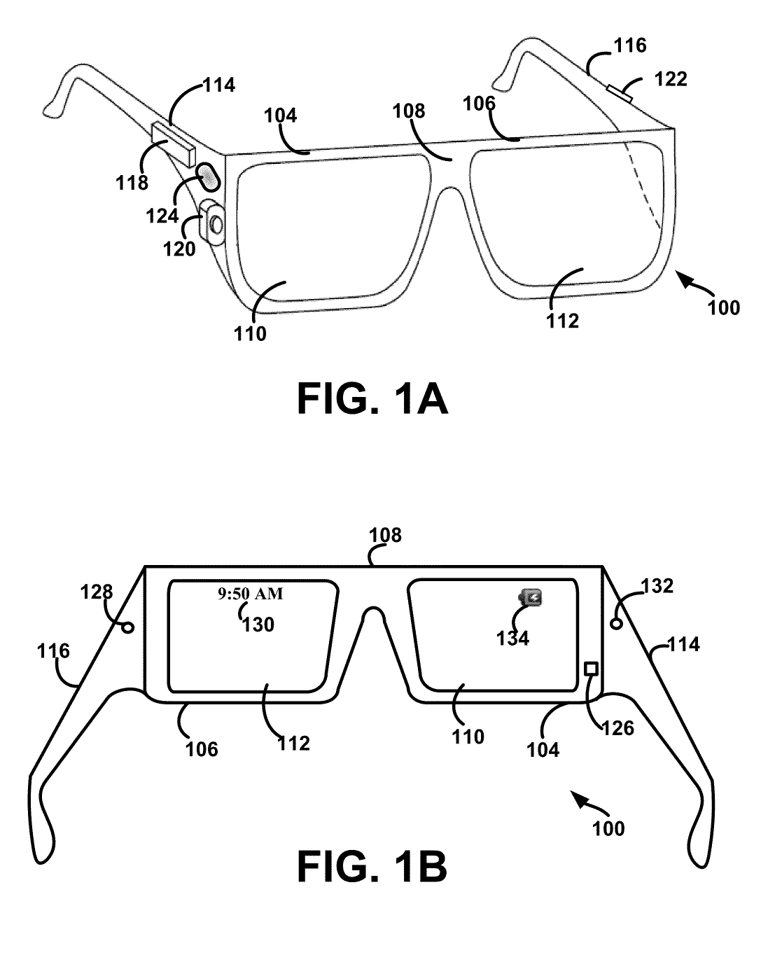

FIG. 1A illustrates an example system 100 for receiving, transmitting, and displaying data. The system 100 is shown in the form of a wearable computing device. While FIG. 1A illustrates the system 100 as a head-mounted device as an example of a wearable computing device, other types of wearable computing devices could additionally or alternatively be used. As illustrated in FIG. 1A, the system 100 has frame elements including lens-frames 104, 106 and a center frame support 108, lens elements 110, 112, and extending side-arms 114, 116. The center frame support 108 and the extending side-arms 114, 116 are configured to secure the system 100 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the system 100. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements 110, 112.

The extending side-arms 114, 116 may each be projections that extend away from the lens-frames 104, 106, respectively, and may be positioned behind a user's ears to secure the system 100 to the user. The extending side-arms 114, 116 may further secure the system 100 to the user by extending around a rear portion of the user's head. Additionally or alternatively, for example, the system 100 may connect to or be affixed within a head-mounted helmet structure. Other possibilities exist as well.

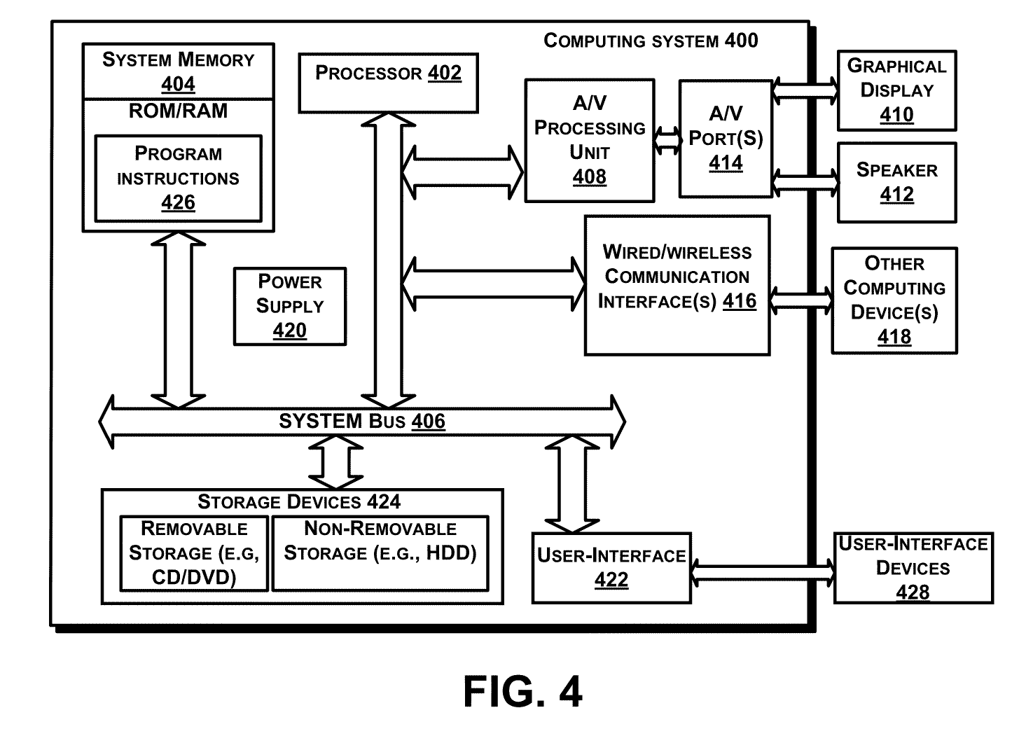

The system 100 may also include an on-board computing system 118, a video camera 120, a sensor 122, and a finger-operable touch pad 124. The on-board computing system 118 is shown to be positioned on the extending side-arm 114 of the system 100; however, the on-board computing system 118 may be provided on other parts of the system 100 or may be positioned remote from the system 100 (e.g., the on-board computing system 118 could be connected by wires or wirelessly connected to the system 100). The on-board computing system 118 may include a processor and memory, for example. The on-board computing system 118 may be configured to receive and analyze data from the video camera 120, the sensor 122, and the finger-operable touch pad 124 (and possibly from other sensory devices, user-interfaces, or both) and generate images for output by the lens elements 110 and 112. The on-board computing system 118 may additionally include a speaker or a microphone for user input (not shown). An example computing system is further described below in connection with FIG. 4.

The video camera 120 is shown positioned on the extending side-arm 114 of the system 100; however, the video camera 120 may be provided on other parts of the system 100. The video camera 120 may be configured to capture images at various resolutions or at different frame rates. Video cameras with a small form-factor, such as those used in cell phones or webcams, for example, may be incorporated into an example embodiment of the system 100.

Further, although FIG. 1A illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer generated images appear to interact with the real-world view perceived by the user.

The sensor 122 is shown on the extending side-arm 116 of the system 100; however, the sensor 122 may be positioned on other parts of the system 100. The sensor 122 may include one or more of a gyroscope or an accelerometer, for example. Other sensing devices may be included within, or in addition to, the sensor 122 or other sensing functions may be performed by the sensor 122.

The finger-operable touch pad 124 is shown on the extending side-arm 114 of the system 100. However, the finger-operable touch pad 124 may be positioned on other parts of the system 100. Also, more than one finger-operable touch pad may be present on the system 100. The finger-operable touch pad 124 may be used by a user to input commands. The finger-operable touch pad 124 may sense at least one of a position and a movement of a finger via capacitive sensing, resistance sensing, or a surface acoustic wave process, among other possibilities. The finger-operable touch pad 124 may be capable of sensing finger movement in a direction parallel or planar to the pad surface, in a direction normal to the pad surface, or both, and may also be capable of sensing a level of pressure applied to the pad surface. The finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

FIG. 1B illustrates an alternate view of the system 100 illustrated in FIG. 1A. The system 100 may include a detector 126. The detector 126 may be, for example, a camera configured to capture images and/or videos in one or more portions of the electromagnetic spectrum (e.g. visible light, infrared, etc.). In one example, the detector 126 may be an eye-facing detector configured to detect the presence or movement of a user's eye. In another example, the detector 126 may be a motion sensing input device that uses, for example, an infrared projector and camera. Thus, the detector 126 may, in some examples, capture three-dimensional (3D) data.

The detector 126 may also include various lenses, optics, or other components to alter the focus and/or direction of the detector 126. Although the detector 126 is shown coupled to an inside surface of the frame element 104, one or more components may be coupled to the frame elements 104, 106, and 108 and/or the extending side-arms 114, 116 in place of and/or in addition to the detector 126 as well.

As shown in FIG. 1B, the lens elements 110, 112 may act as display elements. The system 100 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may be omitted (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or light emitting diode (LED) source and scanning system could be used to draw a raster display directly onto the retina of one or more of the user's eyes. Other possibilities exist as well.

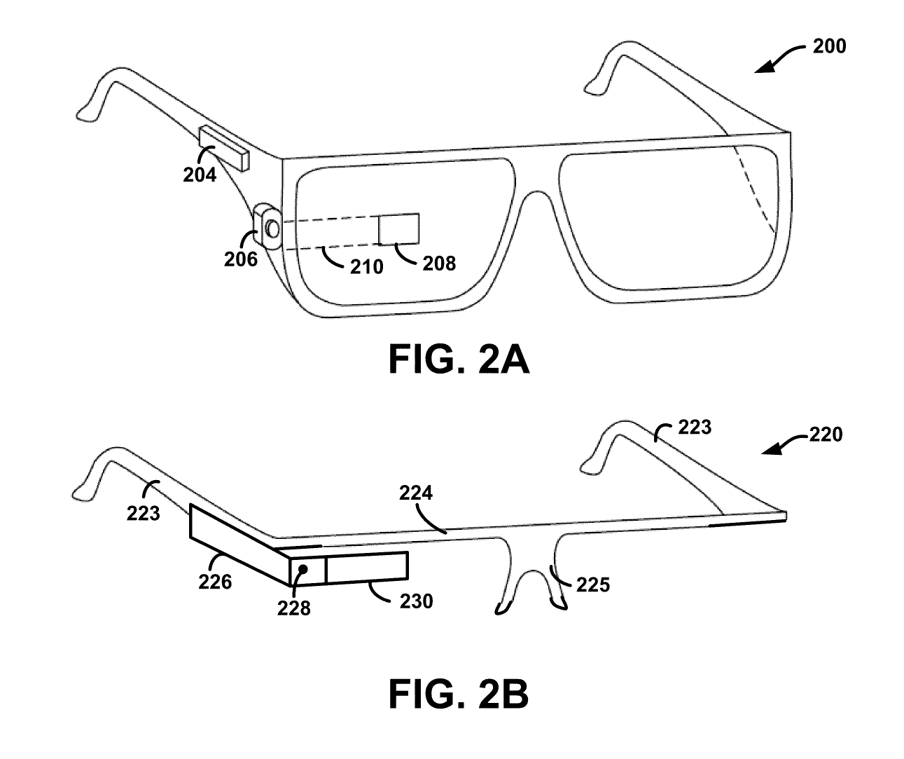

FIG. 2A illustrates an example system 200 for receiving, transmitting, and displaying data. The system 200 is shown in the form of a wearable computing device. The system 200 may include frame elements and side-arms such as those described with respect to FIGS. 1A and 1B. The system 200 may additionally include an on-board computing system 204 and a video camera 206, such as those described with respect to FIGS. 1A and 1B. The video camera 206 is shown mounted on a frame of the system 200; however, the video camera 206 may be mounted at other positions as well.

As shown in FIG. 2A, the system 200 may include a single display 208 which may be coupled to the device. The display 208 may be formed on one of the lens elements of the system 200, such as a lens element described with respect to FIGS. 1A and 1B, and may be configured to overlay computer-generated graphics in the user's view of the physical world. The display 208 is shown to be provided in a center of a lens of the system 200, however, the display 208 may be provided in other positions. The display 208 is controllable via the computing system 204 that is coupled to the display 208 via an optical waveguide 210.

FIG. 2B illustrates an example system 220 for receiving, transmitting, and displaying data. The system 220 is shown in the form of a wearable computing device. The system 220 may include side-arms 223, a center frame support 224, and a bridge portion with nosepiece 225. In the example shown in FIG. 2B, the center frame support 224 connects the side-arms 223. The system 220 does not include lens-frames containing lens elements. The system 220 may additionally include an on-board computing system 226 and a video camera 228, such as those described with respect to FIGS. 1A and 1B.

The system 220 may include a single lens element 230 that may be coupled to one of the side-arms 223 or the center frame support 224. The lens element 230 may include a display such as the display described with reference to FIGS. 1A and 1B, and may be configured to overlay computer-generated graphics upon the user's view of the physical world. In one example, the single lens element 230 may be coupled to a side of the extending side-arm 223. The single lens element 230 may be positioned in front of or proximate to a user's eye when the system 220 is worn by a user. For example, the single lens element 230 may be positioned below the center frame support 224, as shown in FIG. 2B.

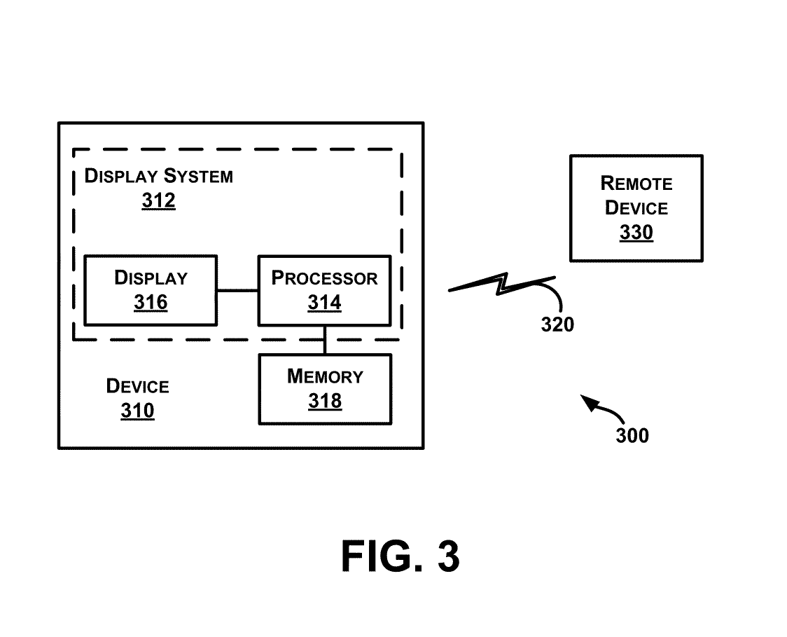

FIG. 3 shows a simplified block diagram of an example computer network infrastructure. In system 300, a device 310 communicates using a communication link 320 (e.g., a wired or wireless connection) to a remote device 330. The device 310 may be any type of device that can receive data and display information corresponding to or associated with the data. For example, the device 310 may be a heads-up display system, such as the system 100, 200, or 220 described with reference to FIGS. 1A-2B.

Thus, the device 310 may include a display system 312 comprising a processor 314 and a display 316. The display 316 may be, for example, an optical see-through display, an optical see-around display, or a video see-through display. The processor 314 may receive data from the remote device 330, and configure the data for display on the display 316. The processor 314 may be any type of processor, such as a micro-processor or a digital signal processor, for example.

The device 310 may further include on-board data storage, such as memory 318 coupled to the processor 314. The memory 318 may store software that can be accessed and executed by the processor 314, for example.

The remote device 330 may be any type of computing device or transmitter including a laptop computer, a mobile telephone, or tablet computing device, etc., that is configured to transmit data to the device 310. Additionally, the remote device 330 may be an additional heads-up display system, such as the systems 100, 200, or 220 described with reference to FIGS. 1A-2B. The remote device 330 and the device 310 may contain hardware to enable the communication link 320, such as processors, transmitters, receivers, antennas, etc.

In FIG. 3, the communication link 320 is illustrated as a wireless connection; however, wired connections may also be used. For example, the communication link 320 may be a wired serial bus such as a universal serial bus or a parallel bus, among other connections. The communication link 320 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. Either of such a wired and/or wireless connection may be a proprietary connection as well. The remote device 330 may be accessible via the Internet and may include a computing cluster associated with a particular web service (e.g., social-networking, photo sharing, address book, etc.).

As described above in connection with FIGS. 1A-2B, an example wearable computing device may include, or may otherwise be communicatively coupled to, a computing system, such as computing system 118 or computing system 204. FIG. 4 shows a simplified block diagram depicting example components of an example computing system 400. One or both of the device 310 and the remote device 330 may take the form of computing system 400.

Computing system 400 may include at least one processor 402 and system memory 404. In an example embodiment, computing system 400 may include a system bus 406 that communicatively connects processor 402 and system memory 404, as well as other components of computing system 400. Depending on the desired configuration, processor 402 can be any type of processor including, but not limited to, a microprocessor (μP), a microcontroller (μC), a digital signal processor (DSP), or any combination thereof. Furthermore, system memory 404 can be of any type of memory now known or later developed including but not limited to volatile memory (such as RAM), non-volatile memory (such as ROM, flash memory, etc.) or any combination thereof

An example computing system 400 may include various other components as well. For example, computing system 400 includes an A/V processing unit 408 for controlling graphical display 410 and speaker 412 (via A/V port 414), one or more communication interfaces 416 for connecting to other computing devices 418, and a power supply 420. Graphical display 410 may be arranged to provide a visual depiction of various input regions provided by user-interface module 422. For example, user-interface module 422 may be configured to provide a user-interface, and graphical display 410 may be configured to provide a visual depiction of the user-interface. User-interface module 422 may be further configured to receive data from and transmit data to (or be otherwise compatible with) one or more user-interface devices 428.

Furthermore, computing system 400 may also include one or more data storage devices 424, which can be removable storage devices, non-removable storage devices, or a combination thereof. Examples of removable storage devices and non-removable storage devices include magnetic disk devices such as flexible disk drives and hard-disk drives (HDD), optical disk drives such as compact disk (CD) drives or digital versatile disk (DVD) drives, solid state drives (SSD), and/or any other storage device now known or later developed. Computer storage media can include volatile and nonvolatile, removable and non-removable media implemented in any method or technology for storage of information, such as computer readable instructions, data structures, program modules, or other data. For example, computer storage media may take the form of RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium now known or later developed that can be used to store the desired information and which can be accessed by computing system 400.

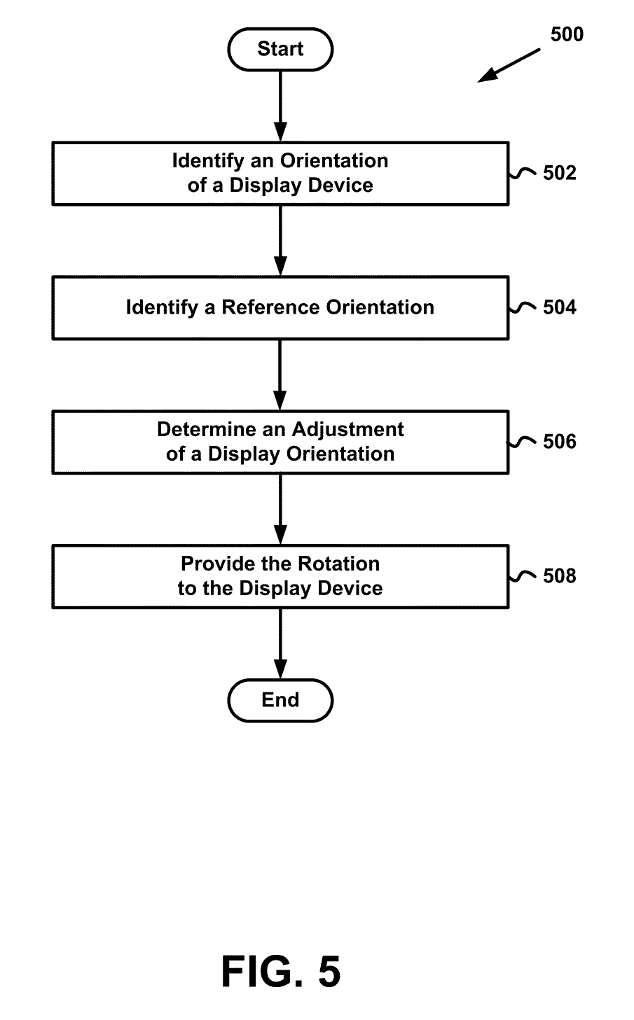

According to an example embodiment, computing system 400 may include program instructions 426 that are stored in system memory 404 (and/or possibly in another data-storage medium) and executable by processor 402 to facilitate the various functions described herein including, but not limited to, those functions described with respect to FIGS. 5-11. Although various components of computing system 400 are shown as distributed components, it should be understood that any of such components may be physically integrated and/or distributed according to the desired configuration of the computing system.

3. Example Determination of a Rotation of Media Displayed on Display Device

FIG. 5 is a block diagram of an example method 500 for determining a rotation of a display orientation of media displayed on a display device by a wearable computing device. Method 500 shown in FIG. 5 presents an embodiment of a method that could be used with any of the systems of FIGS. 1-4, for example, and may be performed by a wearable computing device or component of a wearable computing device, such as one of the head-mounted devices illustrated in FIGS. 1-4. Method 500 may include one or more operations, functions, or actions as illustrated by one or more of blocks 502-508. Although the blocks are illustrated in sequential order, these blocks may be performed in parallel and/or in a different order than those described herein. Also, the various blocks may be combined into fewer blocks, divided into additional blocks, and/or removed based upon the desired implementation.

In addition, for the method 500 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer-readable medium, for example, such as a storage device including a disk or hard drive. The computer-readable medium may include non-transitory computer-readable media, for example, such as a computer-readable media that stores data for short periods of time, such as register memory, processor cache, or Random Access Memory (RAM). The computer-readable medium may also include non-transitory media, such as secondary or persistent long term storage, such as read-only memory (ROM), optical or magnetic discs, compact-disc read-only memory (CD-ROM), or the like. The computer-readable medium may also include any other volatile or non-volatile storage systems. The computer-readable medium may be considered a computer-readable storage medium, for example, or a tangible storage device.

In addition, for the method 500 and other processes and methods disclosed herein, each block of FIG. 5 may represent circuitry that is wired to perform the specific logical functions of the process.

At block 502, the method 500 includes identifying an orientation of a display device in a field of view of a wearable computing device. The wearable computing device may include a head-mounted display, such as the systems 100, 200, and 220 depicted in FIGS. 1A-2B. The wearable computing device may also include a camera mounted to the head-mounted display, such as the cameras 120, 206, and 228 depicted in FIGS. 1A-2B. The wearable computing device may receive information from the camera corresponding to a field of view of the camera. The wearable computing device may also communicate with the display device via a wired or wireless communication link.

The orientation of the display device may include a first axis that is perpendicular to a second axis. In one example, a user wearing the head-mounted display may also use a display device, such as a television, a tablet computer, a notebook or laptop computer, an e-reader, a digital media player, or a similar electronic device capable of displaying media. When the user uses the display device, the user may position the display device such that the user can see the media displayed on the display device. Since the user is wearing the head-mounted display, the field of view of the camera may include the display device. The wearable computing device may employ an object recognition technique to identify an orientation of the display device from the information corresponding to the field of view of the camera.

In another example, the wearable computing device may send an instruction to the display device that includes an instruction for displaying a fiducial on the display device. The fiducial may include a character unique to the communication link and may be either perceptible or imperceptible to human vision. The wearable computing device may identify the fiducial in the information corresponding to the field of view of the camera and determine the orientation of the display device based on a location of the fiducial in the information corresponding to the field of view of the camera. Alternatively, the instruction may include an instruction for displaying a fiducial in each corner of the display device. The wearable computing device may determine the orientation of the display device based on a location of each fiducial in the information corresponding to the field of view of the camera.

In another aspect of this example, the instruction may include an instruction for displaying a watermark on the display device. The watermark may be identifiable by the wearable computing device and imperceptible to human vision. The wearable computing device may identify the watermark in the information corresponding to the field of view of the camera and identify and may determine an orientation of the watermark. The wearable computing device may identify the orientation of the display device based on the orientation of the watermark.

In yet another example, the wearable computing device may identify text displayed on the display device from the information corresponding to the field of view of the camera. The wearable computing device may determine an orientation of the text and, based on the orientation of the text, determine the orientation of the display device.

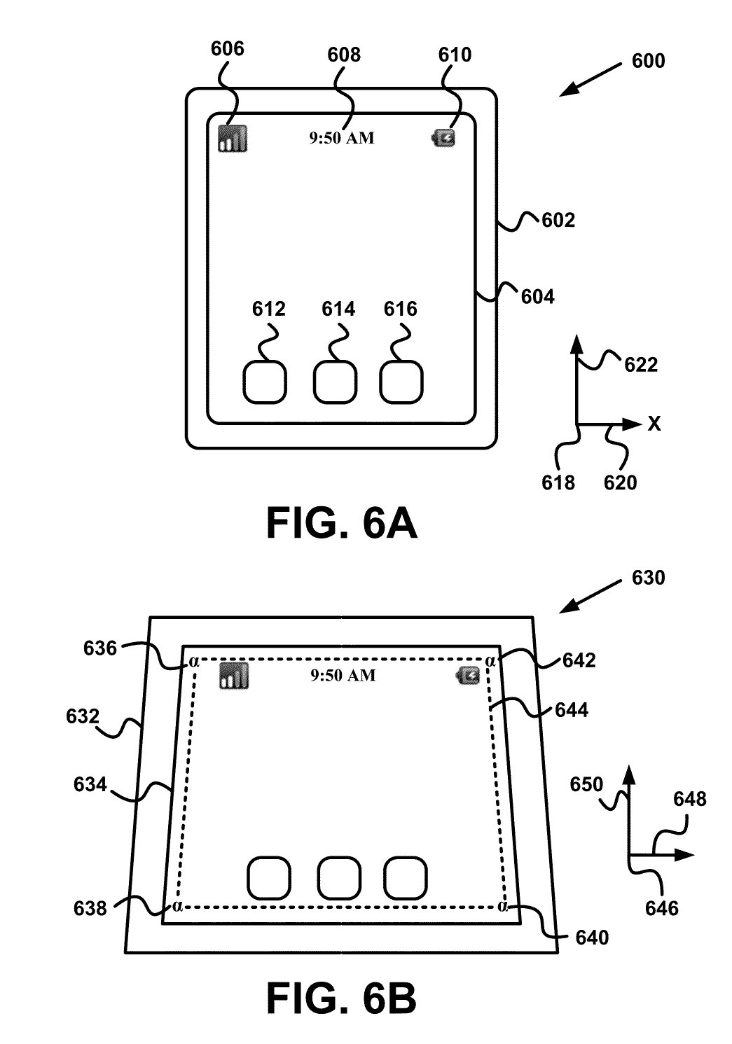

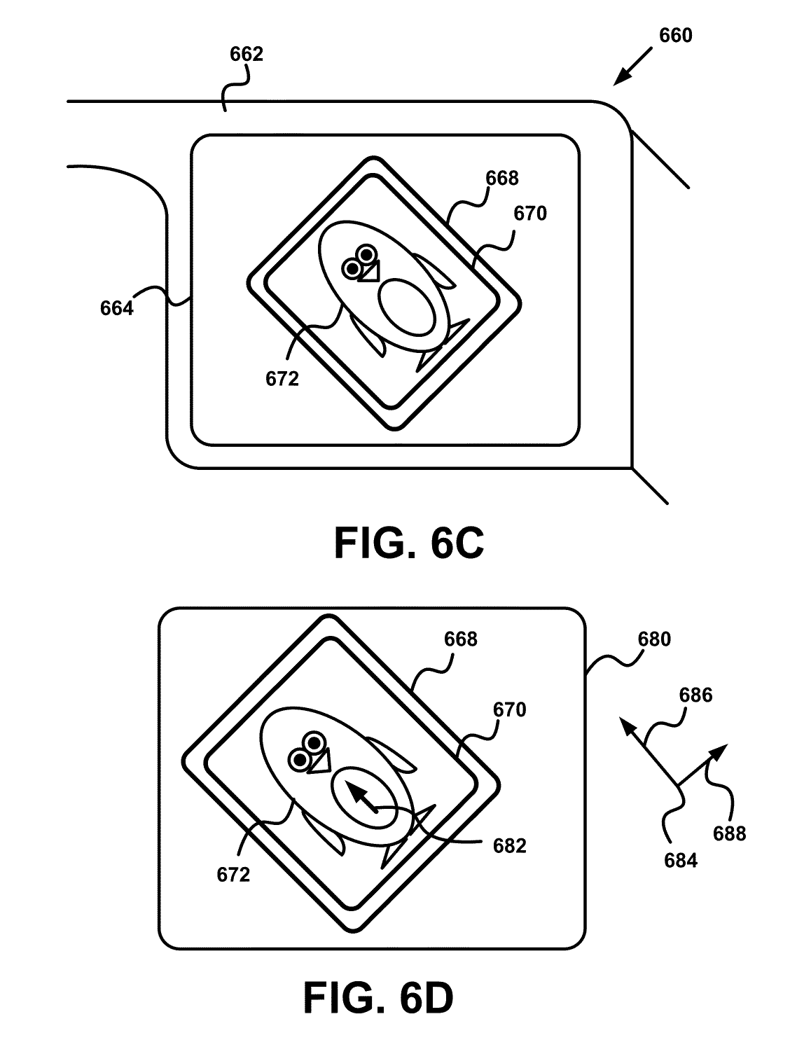

FIGS. 6A-6D illustrate examples of a wearable computing device identifying an orientation of a display device. FIG. 6A includes a view 600 corresponding to a field of view of a camera of a wearable computing device. The view 600 includes a tablet computer 602 having a display 604. The display 604 includes a signal strength indication 606, a time indication 608, a power level indication 610, and application icons 612, 614, and 616.

The wearable computing device may receive information corresponding to the view 600 and identify an orientation 618 of the tablet computer 602, which is shown for illustrative purposes. The orientation 618 of the tablet computer 602 may include a horizontal axis 620 and a vertical axis 622. In one example, the wearable computing device may employ a text recognition technique to identify the time indication 608. The wearable computing device may identify the orientation 618 of the tablet computer 602 based the orientation of the time indication 608.

In another example, the wearable computing device may receive an indication of a location of a fiducial displayed on the display 604 of the tablet computer 602. The fiducial may include one or more of the signal strength indication 606, the power level indication 610, and the application icons 612, 614, and 616. The wearable computing device may identify the fiducial in the information corresponding to the view 600 and identify the orientation 618 of the tablet computer 602 by comparing the location of the fiducial received from the tablet computer to the location of the fiducial in the information corresponding to the view 600.

FIG. 6B includes a view 630 corresponding to a field of view of a wearable computing device. The view 630 includes a tablet computer 632 having a display 634. The wearable computing device may communicate with the tablet computer 632 via a wired or wireless communication link. In this example, the wearable computing device may send an instruction to the tablet computer for displaying fiducials 636, 638, 640, and 642 on the display 634. In response, the tablet computer 602 may display one of the fiducials 636, 638, 640, and 642 in each corner. In the view 630, the fiducials 636, 638, 640, and 642 are Greek alpha characters, though other examples may include other or additional characters.

In the example depicted in view 630, a user of the wearable computing device and the tablet computer 632 holds the tablet computer 632 at an angle. The wearable computing device may determine that the fiducials 636, 638, 640, and 642 form a trapezoid 644, which is shown for illustrative purposes. The wearable computing device may identify the orientation 646 of the tablet computer 632 by aligning a horizontal axis 648 of the orientation 646 of the tablet computer 632 with the base of the trapezoid 644, which is a line connection the fiducials 638 and 640. The orientation 648 of the tablet computer 632 may include a vertical axis 650 that is perpendicular to the horizontal axis 648.

FIG. 6C includes a view 660 from a perspective of a user of wearable computing device that includes a head-mounted display 662. The user may look through a lens 664 and see a tablet computer 668 displaying media 672 on a display 670. The wearable computing device may communicate with the tablet computing device via a wired or wireless communication link. The wearable computing device may provide an instruction for displaying a watermark on the display 670 of the tablet computer 668, and in response the tablet computer 668 may display the watermark on the display 670. However, in this example the display of the watermark is imperceptible to human vision; thus, the user does not see the watermark on the display 670 of the tablet computer 668 in the view 660.

FIG. 6D includes a view 680 corresponding to a field of view of a camera attached to the head-mounted display 642 depicted in FIG. 6C. Since the camera can detect slight changes in the brightness of the pixels, the wearable computing device can identify a watermark 682 on the display 670 of the tablet computer 668. The wearable computing device may identify the orientation 684 of the display device 668 by identifying an orientation of the watermark 682. In this example, the wearable computing device identifies the orientation 684 of the tablet computer 668 by aligning a vertical axis 686 of the orientation 684 of the tablet computer 668 with the orientation of the watermark 682. The orientation 684 of the tablet computer 668 may include a horizontal axis 688 that is perpendicular to the vertical axis 686.

Returning to FIG. 5, the method 500 includes identifying a reference orientation that includes an orientation of the head-mounted display, at block 504. In one example, a wearable computing device may include a head-mounted display, such as one of the systems 100, 200, and 220 depicted in FIGS. 1A-2B. The wearable computing device may also include an inertial measurement unit (IMU) configured to determine an orientation of the head-mounted display, such as the sensor 122 depicted in FIG. 1A. The wearable computing device may receive a signal from the IMU that includes an indication of the orientation of the head-mounted display. The wearable computing device may identify the reference orientation by identifying the orientation of the head-mounted display in the signal received from the IMU.

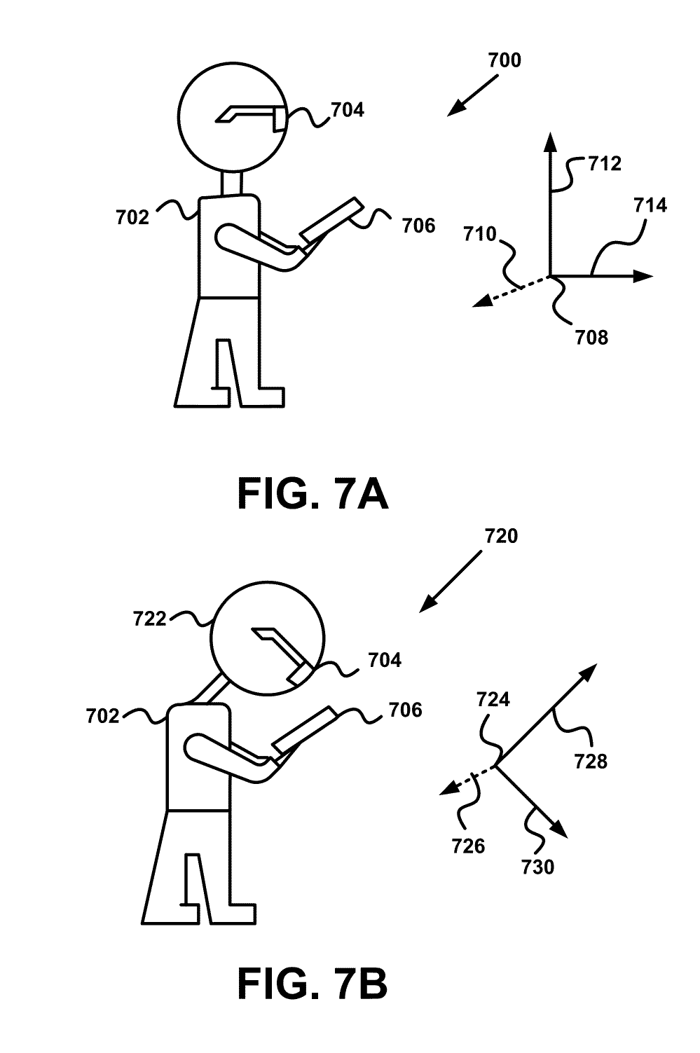

FIGS. 7A-7B illustrate examples of reference orientations based on an orientation of a head-mounted display of a wearable computing device. FIG. 7A shows a view 700 of a user 702 of a wearable computing device that includes a head-mounted display 704. The user 702 holds a tablet computer 706. The wearable computing device may receive a signal from an IMU mounted on the head-mounted display 704 that includes an indication of an orientation of the head-mounted display 704. The wearable computing device may identify the reference orientation 708 by identifying the orientation of the head-mounted display 704 in the signal received from the IMU. The reference orientation may include a horizontal axis 710, a vertical axis 712, and a depth axis 714. The horizontal axis 710 is dashed to give a three-dimensional appearance of the horizontal axis 710 coming out of FIG. 7A.

FIG. 7B illustrates a view 720 in which the user 702 of the wearable computing device has tilted the user's head 722 toward the tablet computer 706. The wearable computing device may receive a signal from the IMU that indicates a new reference orientation 724. The new reference orientation 724 may have a horizontal axis 726, a vertical axis 728, and a depth axis 730. The horizontal axis 726 is dashed to give a three-dimensional appearance of the horizontal axis 726 coming out of FIG. 7B. Because the user 702 rotated the user's head 722 about the horizontal axis 726, the horizontal axis 726 of the new reference orientation 724 may be parallel to the horizontal axis 710 of the reference orientation 708 depicted in FIG. 7A.

Returning to FIG. 5, the reference orientation of the head-mounted display may be independent of a movement of the head-mounted display. For instance, the wearable computing device may perform a calibration procedure to determine an initial orientation of the head-mounted display. The initial orientation of the head-mounted display may include an orientation such as the orientation 708 depicted in FIG. 7A. The wearable computing device may identify the reference orientation as the initial orientation of the head-mounted display.

In another example, a wearable computing device may not include an IMU or a similar sensor configured to determine an orientation of a head-mounted display. In this example the wearable computing device may include a data storage, such as the system memory 404 depicted in FIG. 4. The data storage may include a pre-programmed orientation of the head-mounted display, and the wearable computing device may access the pre-programmed orientation of the head-mounted display from the data storage when identifying the reference orientation.

At block 506, the method 500 includes determining a rotation of a display orientation of media displayed on the display device. The display orientation may include a first axis and a second axis upon which the media is displayed. Applying the rotation to the display orientation may result in aligning one of the first axis and the second axis of the display orientation with a reference axis of a reference orientation. In one example, the wearable computing device may base the rotation on a comparison of an orientation of the display device with a reference orientation. In this example, the wearable computing device may make the comparison by determining an angle between a horizontal axis of the orientation of the display device and a horizontal axis of the reference orientation. In another example, the wearable computing device may determine the comparison by determining an angle between a different axis of the orientation of the display device and a different axis of the reference orientation.

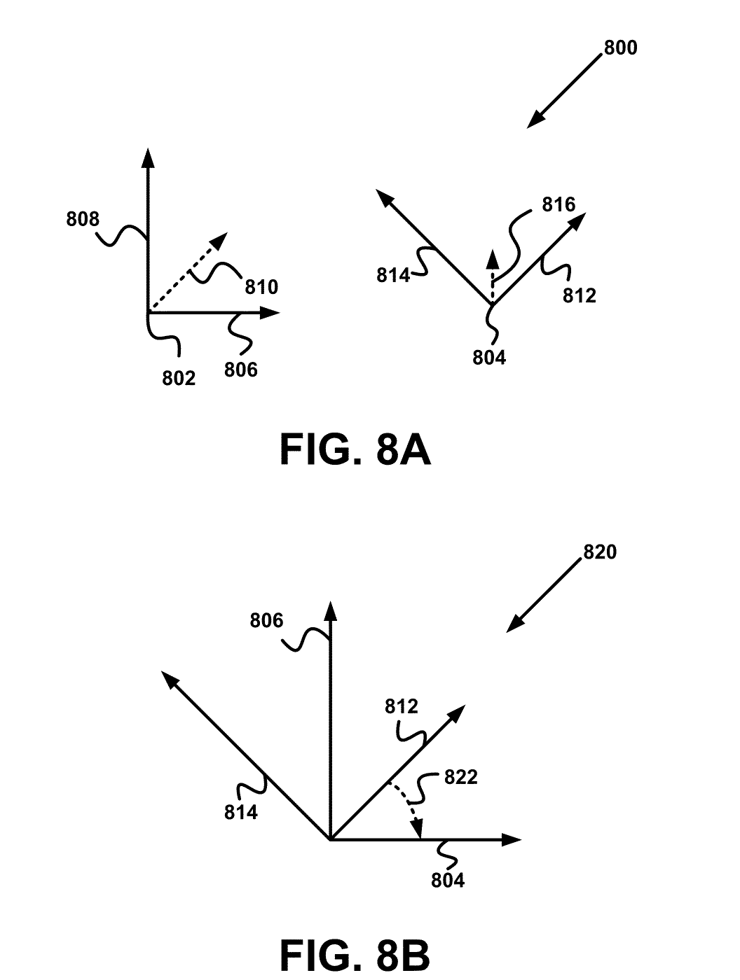

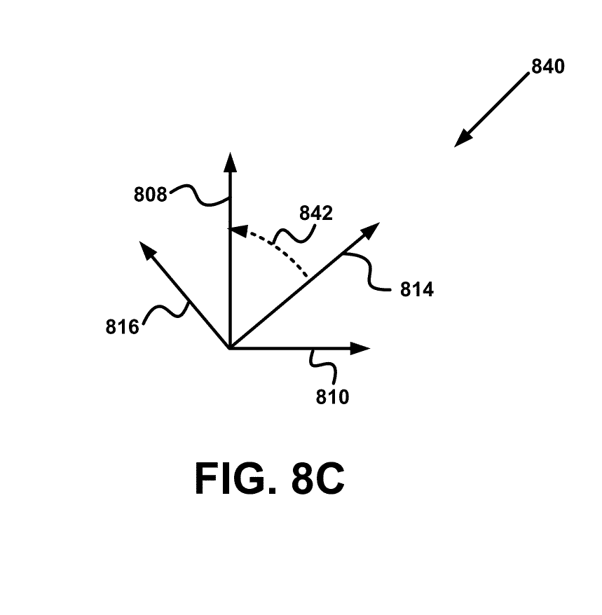

FIGS. 8A-8B illustrate an example of a determination of a rotation of a display orientation based on a comparison of an orientation of a display device with a reference orientation. FIG. 8A includes an example 800 of a reference orientation 802 and an orientation 804 of a display device. A wearable computing device may receive an indication of the reference orientation 804 from a sensor, such as an IMU. The reference orientation 802 may include a horizontal axis 806, a vertical axis 808, and a depth axis 810. The wearable computing device may also identify the orientation 804 of the display device using one of the processes described herein. The orientation 804 of the display device may include a horizontal axis 812 and a vertical axis 814.

FIG. 8B includes an example view 820 in which the reference orientation 802 and the orientation 804 of the display device have a common origin. The wearable computing device may determine an angle 822 from the horizontal axis 812 of the orientation 804 of the display device to the horizontal axis 804 of the reference orientation 802. The wearable computing device may determine that the comparison between the reference orientation 802 and the orientation 804 of the display device is the angle 822, and the wearable computing device may determine the rotation of the display orientation based on the comparison.

Returning to FIG. 5, in another example the wearable computing device may also base the rotation on an indication that a user of the wearable computing device is wearing the wearable computing device. The wearable computing device may include a sensor configured to determine whether the user is wearing the wearable computing device. The wearable computing device may receive a signal from the sensor indicating whether the user is wearing the wearable computing device.

For example, consider a situation in which a user is watching media on a tablet computer while wearing a head-mounted display of the wearable computing device. The wearable computing device may receive a first signal from the sensor indicating that the user is wearing the head-mounted display, and the wearable computing device may determine a rotation of a display orientation of the media as described herein. The user may subsequently take the head-mounted display off and set the head-mounted display on a surface such that the field of view of a camera mounted to the head-mounted display includes the tablet computer. The wearable computing device may receive a second signal from the sensor indicating that the user is not wearing the wearable computing device. In this case, the wearable computing device may not determine a rotation of the display orientation.

At block 508, the method 500 includes providing information indicative of a rotation of a display orientation to a display device. In one example, a wearable computing device may communicate with the display device via a wired or wireless communication link. The wearable computing device may send information indicative of the rotation to the display device via the communication link.

The information indicative of the rotation may include additional information for displaying the media on the display device. In one example, the information indicative of the rotation may include an indication of an aspect ratio of the media displayed on the display device. In this example, the display device may display the media in one of a first aspect ratio and a second aspect ratio, such as a portrait aspect ratio and a landscape aspect ratio. The wearable computing device may base the indication of the aspect ratio on the rotation of the display orientation. For instance, rotation is less than or equal to a threshold angle, the information indicative of the rotation may include an indication that the display device should display the media using the first aspect ratio. If the angle is greater than the threshold angle, the information indicative of the rotation may include an indication that the display device should display the media using the second aspect ratio.

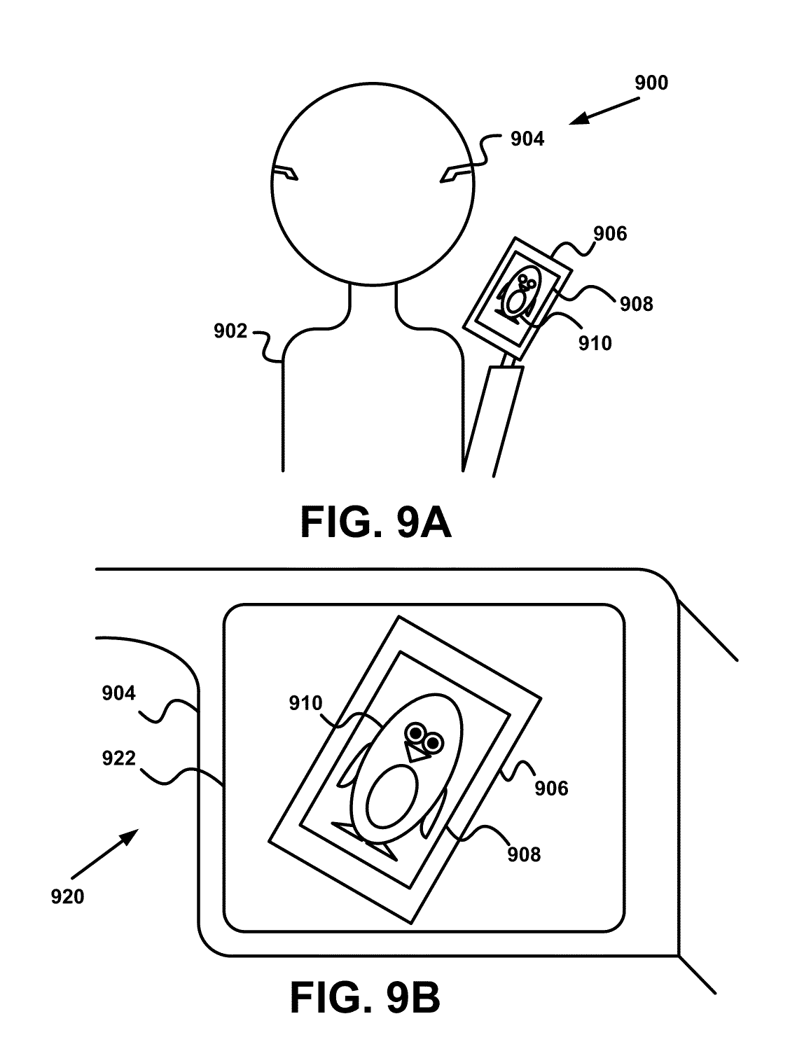

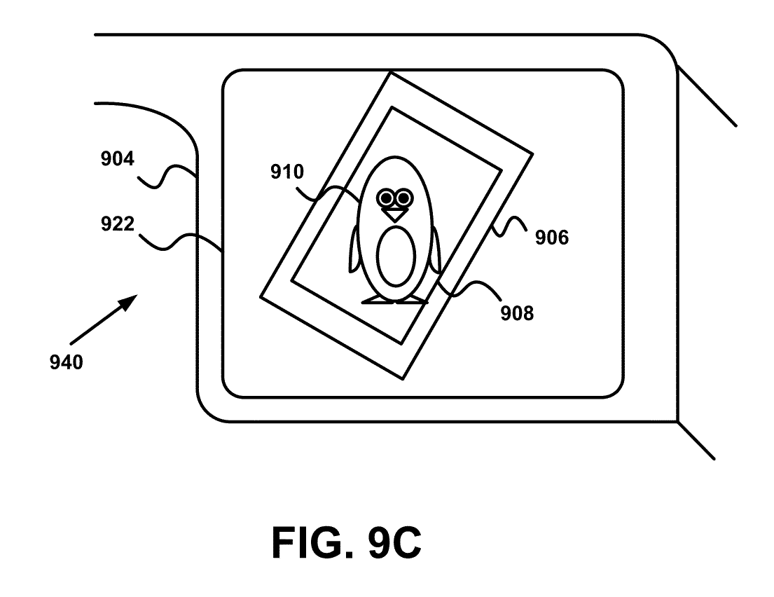

FIGS. 9A-9C illustrate an example of a wearable computing device implementing a portion of the method 500 to rotate a display orientation of media displayed on a display device. FIG. 9A includes a view 900 of a user 902 of a wearable computing device that includes a head-mounted display 904. The user 902 holds a tablet computer 906 that displays media 910 on a display 908. The user 902 may hold the tablet computer 906 at an angle, as depicted in the view 900.

FIG. 9B includes a view 920 of the user 902 through a lens 922 of the head-mounted display 904. Because the user 902 holds the tablet computer 906 at an angle, the media 910 appears to user as being tilted to the user's right. The wearable computing device may perform a portion of the method 500 to determine a rotation of the display orientation of the media 910 such that a horizontal axis of the display orientation is parallel to a horizontal axis of a reference orientation, which is based on an orientation of the head-mounted display 904. The wearable computing device may provide the rotation to the tablet computer 906.

FIG. 9C includes a view 940 of the user 902 through the lens 922 of the head-mounted display 904 after the tablet computer 906 has applied the rotation to the display orientation of the media 910. Applying the rotation results in the user 902 viewing the media 910 on the display 908 of the tablet computer 906 as though the user 902 was not holding the tablet computer 906 at angle.

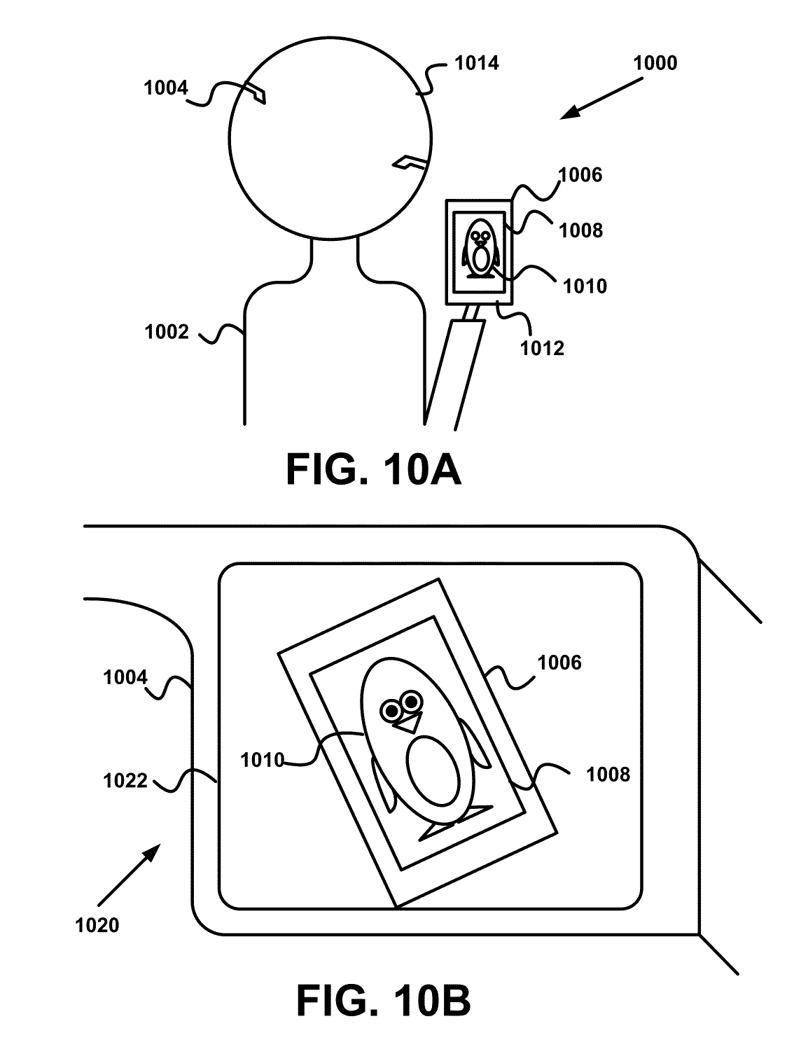

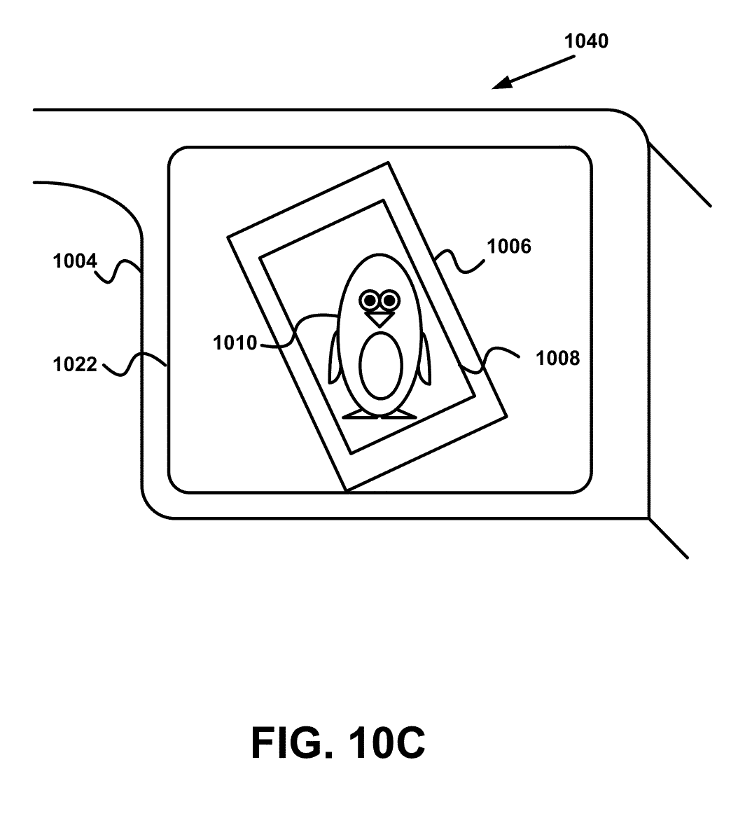

FIGS. 10A-10C illustrate another example of a wearable computing device implementing a portion of the method 500 to rotate a display orientation of media displayed on a display device. FIG. 10A includes a view 1000 of a user 1002 of a wearable computing device that includes a head-mounted display 1004. The user 1002 holds a tablet computer 1006 that displays media 1010 on a display 1008. The user 1002 may hold the tablet computer 1006 such that a base 1012 of the tablet computer 1006 is parallel to the ground. The user 1002 may also tilt the user's head 1014 to the user's right, as depicted in the view 1000.

FIG. 10B includes a view 1020 of the user 1002 through a lens 1022 of the head-mounted display 1004. Because the user's head 1014 is tilted to the user's right, the media 1010 displayed on the display 1008 of the tablet computer 1006 appears to be tilted to the user's left, as depicted in the view 1020. The wearable computing device may perform a portion of the method 500 to determine a rotation of the display orientation of the media 1010 such that a horizontal axis of the display orientation is parallel to a horizontal axis of a reference orientation, which is based on an orientation of the head-mounted display 1004. The wearable computing device may provide the rotation to the tablet computer 1006.

FIG. 10C includes a view 1040 of the user 1002 through the lens 1022 of the head-mounted display 1004 after the tablet computer 1006 has applied the rotation to the display orientation of the media 1010. Applying the rotation results in the user 1002 viewing the media 1010 on the display 1008 of the tablet computer 1006 as though the user's head 1014 was not tilted to the user's 1002 right.

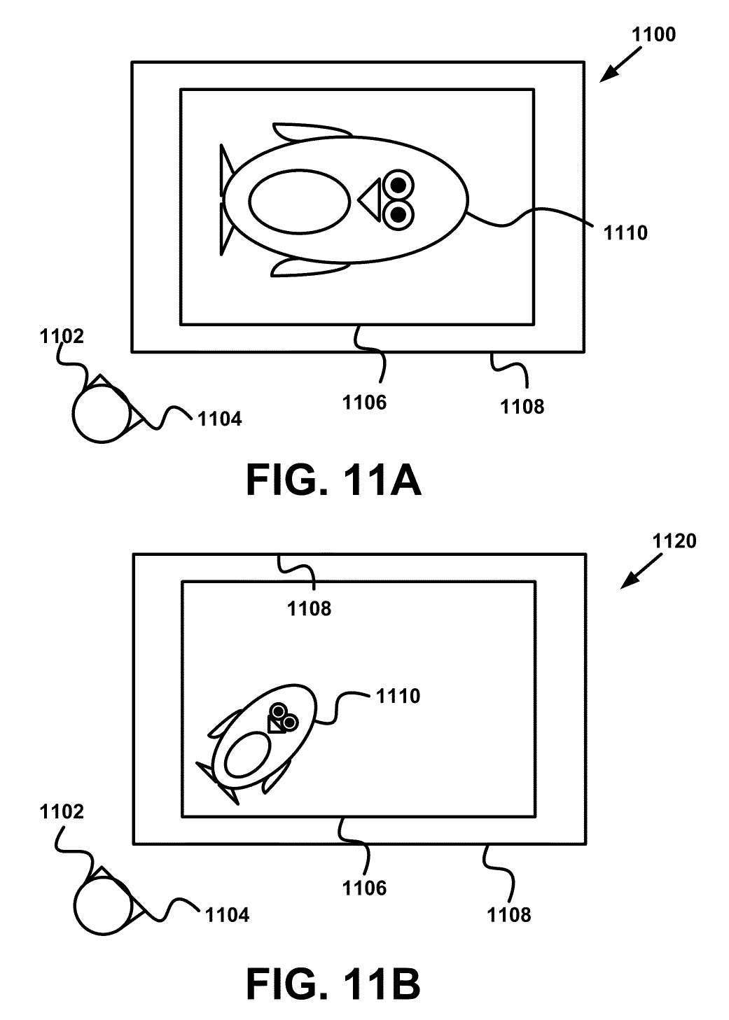

FIGS. 11A-11B illustrate yet another example of a wearable computing device implementing a portion of the method 500 to adjust a display orientation of media displayed on a display device. FIG. 11A includes a top-down view 1100 of a user 1102 of a wearable computing device 1004. The view 1100 also includes a display device 1106 mounted horizontally on a table 1108. For illustrative purposes, the display device 1106 is a television displaying media 1110. The wearable computing device may perform a portion of the method 500 to rotate the display orientation of the media 1110 such that a horizontal axis of the display orientation of the media is parallel to a horizontal axis of a reference orientation, which is based on an orientation of the head-mounted display. The wearable computing device may provide information indicative of the rotation to the display device 1106.

FIG. 11B includes a top-down view 1120 of the view 1100 after the display device has applied the rotation to the display orientation of the media 1110. The media 1110 depicted in the view 1120 has an appearance of being centered on the user 1102 because the horizontal axis of the display orientation of the media 1110 is parallel to the horizontal axis of the reference orientation. Additionally, the wearable computing device may have determined that the of the display orientation of the media 1110 was greater than a threshold angle. The wearable computing device may have included in the information indicative of the rotation an indication of a change in the aspect ratio from a first aspect ratio to a second aspect ratio, such as a change from a landscape aspect ratio to a portrait aspect ratio as depicted in the view 1120.

Returning to FIG. 5, the method 500 may end upon completing the steps of block 508. A wearable computing device may perform a portion of the method 500 in order to update the rotation of the display orientation. For instance, the wearable computing device may update the rotation upon identifying a change in the orientation of the display device. Likewise, the wearable computing device may update the rotation upon identifying a change in the reference orientation.

It should be understood that arrangements described herein are for purposes of example only. As such, those skilled in the art will appreciate that other arrangements and other elements (e.g., machines, interfaces, functions, orders, groupings of functions, etc.) can be used instead, and some elements may be omitted altogether according to the desired result. Further, many of the elements described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also understood that the terminology used herein is for the purpose of describing particular embodiments only, and is not intend to be limiting.

1. A method comprising:
receiving, at a wearable computing device, information corresponding to a field of view of a camera of the wearable computing device, wherein the field of view includes a display device;
receiving, at the wearable computing device and from the display device, an indication of a fiducial displayed on the display device;
based on the received indication, identifying a position of the fiducial in the information corresponding to the field of view of the camera;
based on the identified position of the fiducial in the information corresponding to the field of view of the camera, identifying, by the wearable computing device, an orientation of the display device;
identifying, by the wearable computing device, a reference orientation that includes an orientation of the wearable computing device;
determining, by the wearable computing device, a rotation of a display orientation of media displayed on the display device based on a comparison of the orientation of the display device with the reference orientation; and
sending from the wearable computing device to the display device information indicative of the rotation of the display orientation.

2. The method of claim 1, wherein identifying the orientation of the display device comprises:
sending from the wearable computing device to the display device an instruction for displaying the fiducial on the display device.

3. The method of claim 2, wherein the instruction for displaying the fiducial includes an instruction for displaying the fiducial such that the fiducial is identifiable by the wearable computing device and is imperceptible to human vision.

4. The method of claim 2, wherein the fiducial includes a unique character displayed in at least one corner of the display device.

5. The method of claim 2, wherein the fiducial includes a watermark of an image.

6. The method of claim 1, wherein identifying the orientation of the display device comprises:
identifying an orientation of text displayed on the display device from the information corresponding to the field of view of the camera.

7. (canceled)

8. The method of claim 1, wherein the reference orientation is independent of a movement of the wearable computing device.

9. The method of claim 1, wherein the wearable computing device includes a head-mounted display, wherein the orientation of the wearable computing device includes an orientation of the head-mounted display.

10. The method of claim 9, wherein the wearable computing device includes a sensor configured to identify the orientation of the head-mounted display, wherein identifying the reference orientation includes receiving a signal from the sensor that includes an indication of the orientation of the head-mounted display.

11. The method of claim 1, further comprising:
determining an angle between an axis of the orientation of the display device and the reference axis, wherein the comparison of the orientation of the display device with the reference orientation is based on the angle.

12. The method of claim 1, wherein the rotation aligns the display orientation with the reference orientation such that an axis of the display orientation is about parallel to an axis of the reference orientation.

13. The method of claim 1, wherein determining the rotation of the display orientation includes receiving an indication that the wearable computing device is being worn.

14. The method of claim 1, wherein the information indicative of the rotation includes an indication of an aspect ratio of the media displayed on the display device, wherein the indication of the aspect ratio includes:
a first indication for displaying the media with a first aspect ratio when the rotation of the display orientation is less than or equal to a threshold angle;
and a second indication for displaying the media with a second aspect ratio when the rotation of the display orientation is greater than the threshold angle.

15. A non-transitory computer readable memory having stored therein instructions executable by a computing device to cause the computing device to perform functions comprising:
receiving, at a wearable computing device, information corresponding to a field of view of a camera of the wearable computing device, wherein the field of view includes a display device;
receiving, at the wearable computing device and from the display device, an indication of a fiducial displayed on the display device;
based on the received indication, identifying by the wearable computing device a position of the fiducial in the information corresponding to the field of view of the camera;
based on the identified position of the fiducial in the information corresponding to the field of view of the camera, identifying, by the wearable computing device, an orientation of the display device;
identifying, by the wearable computing device, a reference orientation that includes an orientation of the wearable computing device;
determining, by the wearable computing device, a rotation of a display orientation of media displayed on the display device based on a comparison of the orientation of the display device with the reference orientation; and
sending from the wearable computing device to the display device information indicative of the rotation of the display orientation.

16. The non-transitory computer readable memory of claim 15, wherein the instructions are further executable by the computing device to cause the computing device to perform functions comprising:
sending from the wearable computing device to the display device an instruction for displaying the fiducial on the display device.

17. (canceled)

18. A wearable computing device comprising:
a camera having a field of view; and
a processor configured to:
receive information corresponding to a field of view of the camera that includes a display device;
receive from the display device an indication of a fiducial displayed on the display device;
based on the received indication, identify a position of the fiducial in the information corresponding to the field of view of the camera;
based on the identified position of the fiducial in the information corresponding to the field of view of the camera, identify an orientation of the display device;
identify a reference orientation that includes an orientation of the wearable computing device;
determine a rotation of a display orientation of media displayed on the display device based on a comparison of the orientation of the display device with the reference orientation; and
send to the display device information indicative of the rotation of the display orientation.

19. The wearable computing device of claim 18, further comprising:
a head-mounted display; and
a sensor configured to identify an orientation of the head-mounted display, wherein the processor is further configured to:
receive a signal from the sensor that includes an indication of the orientation of the head-mounted display, wherein the orientation of the wearable computing device includes the orientation of the head-mounted display.

20. The wearable computing device of claim 18, wherein the processor is further configured to:
determine an angle between an axis of the orientation of the display device and the reference axis, wherein the comparison of the orientation of the display device with the reference orientation is based on the angle.
